(19) United States
(12) Patent Application Publication
(10) Pub. No.: US 2002/0166059 A1
(43) Pub. Date: Nov. 7, 2002

(54) Methods and apparatus for protecting against viruses on partitionable media

(76) Inventors: Albert E. Rickey, Round Rock, TX (US); Curtis E. Stevens, Irvine, CA (US)

Correspondence Address: Claudia Cameron, Phoenix Technologies Ltd., 411 East Plumeria Drive, San Jose, CA, 95134, US

(21) Appl. No.: 09/847,812

(22) Filed: May 1, 2001

(51) Int. Cl. H04L 9/00

(52) U.S. Cl. 713/200

(57) ABSTRACT

Apparatus and methods that protect against boot sector viruses on partitioned media of a computer system. The apparatus and methods incorporate code in system firmware, or basic input/output system (BIOS) that parses the partition table. The Apparatus and methods thus provide virus protection implemented by the system firmware (BIOS). Exemplary boot sector virus protection apparatus and methods comprise a computer system having a nonvolatile memory and a mass storage device with a master boot record containing a partition table. The apparatus and methods store code in the nonvolatile memory that is capable of reading the partition table in the master boot record stored in the mass storage device, or stored in a secure area of the mass storage device. The stored code is used to read the master boot record, locate the partition table in the master boot table, locate a bootable partition within the partition table, and begin a boot process using the bootable partition. A checksum of the master boot record or its partition table, or a cyclic redundancy check of the master boot record or its partition table are preferably used.

### BACKGROUND

The present invention relates generally to computer systems and methods, and more particularly, to apparatus and methods for protecting against boot sector viruses on partitionable media. The present invention also relates to loading an operating system from a mass storage device, and specifically to protecting against viruses that install themselves into a boot sector of a mass storage device. The present invention also relates to electronic systems that load their operating system from mass storage devices, which a virus may infect.

Before a computer can properly function, it loads an operating system into its working memory. The operating system (OS), such as Windows, Linux, Unix, VMS or any other operating system, provides the capability by which the user and applications interact with the computer hardware. This process is ordinarily carried out by a process called “bootstrapping,” or “booting.” Booting occurs automatically when a computer is powered on or can be specifically invoked by a user on a running computer.

Typically, the booting process of a computer searches a storage medium (floppy disk, hard drive, or CD-ROM) for an operating system to be loaded, and this function is usually controlled by firmware stored in one or more flash memory components or chips in the computer that include the basic input/output system (BIOS). After locating a disk with a valid boot record, the BIOS program reads the data stored on the first sector of the disk and copies that data into specific locations in the computer's random access memory (RAM). In a typical, personal computer, this data constitutes a DOS Boot Record (DBR). Execution of code contained in the DOS Boot Record causes the computer to load the remaining files and code that comprise the operating system.

The booting process for personal computers is initiated when the system software (BIOS) loads and executes a small program (boot sector code) from the first (boot) sector of a mass storage device, such as a hard drive, a floppy drive or a CD-ROM. The purpose of the boot sector program is to locate the operating system on the mass storage device, load it into memory and execute it. Once the operating system has been executed, the boot sector program is finished, and will not regain control.

Computer viruses are sequences of computer instructions that are installed on computers without the consent of the computer user. Computer viruses can be harmless, destructive, or anywhere in between. A common location within a computer, especially a personal computer, to install a virus is the boot sector of a hard or floppy disk. The boot sector is a common target because it is easy to locate, usually located on sector 0 of the disk. In addition, several predetermined system files can be found by referencing pointers stored within sector 0 of the hard or floppy disk. Since these critical system files are also easily located the are also common targets for viruses.

Viruses are typically undesired programs or segments of code, which are present in the computer system without a user's knowledge or consent. A common method of virus infection is to replace the boot sector code with virus code so that the virus will be activated whenever the infected media is booted from. Typically, at the time of infection, the virus will move the original boot sector program to a hidden location on the drive, and will write a copy of itself into the boot sector. At boot time, if the boot disk is infected, the BIOS will unknowingly load and execute the virus from the boot sector. Once the virus has completed it's task, it typically will load and execute the original boot sector program from the hidden location on the disk. This will cause the operating system to be loaded, and will most likely not alert the user that a virus is present.

The basic input/output system (BIOS) developed by the assignee of the present invention, known as the PhoenixBIOS, has a feature for protecting the boot sector from virus infection. The current virus protection involves runtime monitoring of interrupt 13h write requests. If a write request to the boot sector is made, the BIOS will warn the user about it, or reject the write operation. This method of virus protection may be thwarted by bypassing the interrupt 13h interface, and performing a controller level disk write operation.

However, by bypassing the interrupt 13 interface and performing a controller level disk write, one can thwart this method of virus protection. In other words, in order to detect a virus being written to the boot sector, the Phoenix BIOS typically has to monitor interrupt 13h write requests. If the BIOS detects a write request to the boot sector, then the user will be warned that a disk write is about to occur at the boot sector.

Since there is usually no valid reason to write to the boot sector, a write operation to the boot sector is likely a virus in the process of installing itself to the boot sector. Performing a direct controller level disk write and bypassing the interrupt 13h write request can thwart this method of virus protection. By not utilizing the interrupt 13h to perform a write request to the boot sector and writing the virus into the boot sector directly through the controller without the use of the BIOS code, the installation of the boot virus can avoid detection.

There are several methods in the industry that attempt to prevent virus infections. One approach is that used by the Windows NT operating system. Windows NT stores part of the boot loader in a file on the disk and validates the boot sector contents from the boot loader. This is different from the present invention. The Windows NT operating system performs a checksum type calculation on the boot sector and compares the result to a stored value before executing the code in the boot sector. If the numbers do not match, then it is likely that the boot sector code has been replaced by an alternate code and the user is then warned.

A computer search was performed on the present invention that resulted in several patents that somewhat relate to the present invention. These patents include U.S. Pat. No. 5,559,960 and U.S. Pat. No. 5,826,012. U.S. Pat. No. 5,559,960 entitled “Software anti-virus facility” discloses that a “virus-resistant disk has a “hidden partition” in which anti-virus software is stored; the hidden partition not only shields the software from many viruses, but provides storage space that does not reduce the disk's formatted or advertised capacity. The disk includes software to cause the computer to execute the anti-virus software. The invention provides a hidden partition by utilizing storage space on the disk that is not reflected in the size and geometry information stored on the disk, e.g., in the BIOS Parameter Block.” However, U.S. Pat. No. 5,559,960 does not disclose the use of BIOS that includes Master Boot Record code or that the computer system is booted to load an operating system from the mass storage device without executing the boot sector code so that viruses are not activated.

U.S. Pat. No. 5,826,012 entitled “Boot-time anti-virus and maintenance facility” discloses that a “computer storage medium has software executed at startup of the computer, before the computer executes an ultimate operating system. The software provides anti-virus, maintenance and/or repair functions. In one embodiment, the software is stored on a “hidden partition” of the storage medium; the hidden partition not only shields the software from many viruses, but provides storage space that does not reduce formatted or advertised capacity.”

It is also stated in U.S. Pat. No. 5,826,012 that the “invention provides a storage medium on which is stored anti-virus software and/or software designed to detect and repair damage to stored information, as well as instructions to cause a computer to execute the software whenever the disk is used to start the computer. The invention may be broadly applied to a variety of storage media amenable to selective actuation by a user—that is, designation by the user as a temporary or permanent “system” device from which the computer can boot.” However, U.S. Pat. No. 5,826,012 does not disclose the use of BIOS that includes Master Boot Record code or that the computer system is booted to load an operating system from the mass storage device without executing the boot sector code so that viruses are not activated.

It would be desirable to have virus protection apparatus and methods that improve upon the prior art solutions discussed above. It is an therefore an objective of the present invention to provide for apparatus and methods for protecting against boot sector viruses on partitionable media. It is a further objective of the present invention to provide for apparatus and methods for protecting against boot sector viruses by incorporating code to parse the partition table into the basic input/output system (BIOS).

### SUMMARY OF THE INVENTION

To accomplish the above and other objectives, the present invention provides for apparatus and methods that protect against boot sector viruses on partitioned media of a computer system by incorporating code to parse the partition table into system firmware (basic input/output system or BIOS). The present boot sector virus protection apparatus and methods provide for virus protection implemented by system firmware (BIOS).

Exemplary boot sector virus protection apparatus and methods comprise a computer system having a nonvolatile memory and a mass storage device with a master boot record containing a partition table. The apparatus and methods store code in the nonvolatile memory that is capable of reading the partition table in the master boot record stored in the mass storage device or in a secure area of the mass storage device. The stored code is used to read the master boot record, locate the partition table in the master boot table, locate a bootable partition within the partition table, and begin a boot process using the bootable partition. A checksum of the master boot record or its partition table, or a cyclic redundancy check of the master boot record or its partition table is preferably used.

The present invention adds a new level of virus protection to the system firmware (BIOS) by eliminating the need to execute boot sector code when booting from a mass storage device, such as a hard drive, for example. This is accomplished by moving the functionality of the hard drive boot sector program, known as the Master Boot Record (MBR) into the system firmware (BIOS).

The Master Boot Record is a 512 byte binary image that contains a 446 byte Master Boot Record code section, a 4 entry (64 byte) partition table, and a 2 byte validation signature. The purpose of the Master Boot Record code section is to locate and active partition table entry. If an active partition is found, the Master Boot Record code loads the first sector of the partition, and executes it.

When a virus infects a hard drive boot sector, it typically replaces the Master Boot Record code with virus code, but leaves the partition table intact. The virus in most cases will copy the Master Boot Record code in an unused sector in the boot track, and use it to boot the operating system, after it has installed a runtime piece of virus code, such as an interrupt service routine (ISR).

The present invention places the entire functionality of the Master Boot Record code into the system firmware (BIOS). Therefore, it is not necessary to execute the Master Boot Record code. This prevents and infected drive from spreading a virus.

To augment the present invention, a checksum of the boot sector may be calculated and stored so that a warning may be given to a user in the event that the stored checksum does not match a checksum computed when booting the computer system.

Various advantages of the boot sector virus protection method are as follows. The boot sector virus protection method stops virus infection because infected boot sectors are not executed. The boot sector virus protection method is nonexclusive of existing virus protection, so it may be used to augment existing Phoenix BIOS boot sector protection.

The boot sector virus protection method is passive, in that it does not require a runtime component. The boot sector virus protection method is operating system independent, wherein the boot process up to the point of loading the operating system boot record is standard for all personal computer operating systems.

The present invention is updateable. Since there is no runtime component, a setup feature may be used to copy the 446 byte code section of a Master Boot Record to an Extended System Configuration Data (ESCD) memory area, which is a storage area of memory for storing information about plug-and-play (PnP) devices, for example, in the BIOS, and which would become the boot loader for the BIOS. Windows and the BIOS have access to the Extended System Configuration Data memory area each time the computer re-booted.

The present boot sector virus protection method does not involve active virus detection, and does not prohibit boot sector writes. Instead, the boot sector virus protection method moves the functionality of the boot sector program into the BIOS so that the boot sector program would not need to be executed.

### BRIEF DESCRIPTION OF THE DRAWINGS

The various features and advantages of the present invention may be more readily understood with reference to the following detailed description taken in conjunction with the accompanying drawing, wherein like reference numerals designate like structural elements, and in which:

FIG. 1 is a block diagram showing components of a typical computer system in which the present invention may be employed;

FIG. 2 is a diagram illustrating an operating environment in which system firmware (BIOS) functions provide access to one or more mass storage devices;

FIG. 3 is a table illustrating the structure of a DOS hard disk drive;

FIG. 4 is a table illustrating a standard Master Boot Record;

FIG. 5 shows the structure of a partition table contained in the Master Boot Record;

FIG. 6 is a flow diagram that illustrates a one-time system initialization procedure that includes steps to implement an exemplary virus protection method in accordance with the principles of the present invention;

FIG. 7 is a flow diagram that illustrates an alternative one-time system initialization procedure that includes steps that implement the present virus protection method;

FIG. 8 is a flow diagram of a procedure that illustrates execution of embedded BIOS boot code subsequent to performing steps in the procedures described with reference to FIGS. 6 and 7; and

FIG. 9 is a flow diagram illustrating a boot process according to a simplified embodiment of the present invention.

### DETAILED DESCRIPTION

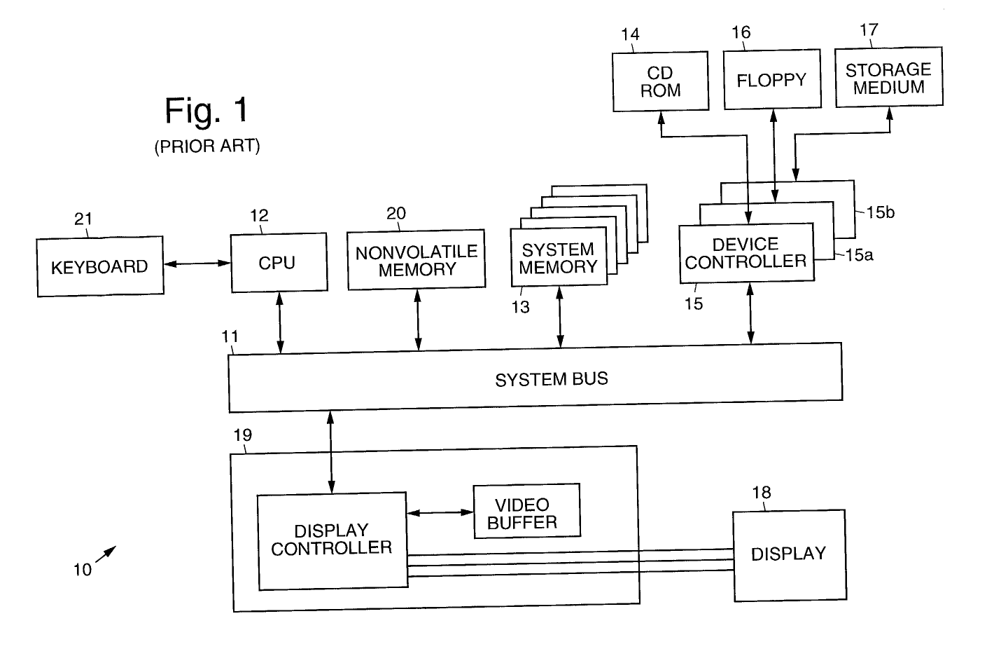

Referring to the drawing figures, FIG. 1 is a block diagram showing components of a typical computer system 10 in which the present invention may be employed. The computer system 10 includes a system bus 11 which connects the different components of the computer system 10 including a central processing unit (CPU) 12, a nonvolatile memory 20, and a main or system memory 13. Data is stored on mass storage devices 14, 16, 17 of the system 10. Data may be stored on compact disks (CDs) with a CD-ROM 14 that can be accessed by the CPU 12 through a device controller 15. Other data, stored on floppy disks using a floppy disk drive 16 or stored on media of a hard disk drive 17 can also be accessed by the CPU 12 through corresponding device controllers 15a, 15b. Other standard components of the computer system 10 include a data input device 21, such as a keyboard 21, and a data display device 18 that typically includes a video buffer, that is connected to the system bus 11 via a video controller 19.

The hard disk drive 17 mass storage device may be a hard disk drive, Zip drive, a magneto-optical drive, a rewritable compact disk, a superdisk, a high density floppy disk, or a solid state disk drive, for example. The nonvolatile memory 20 may be a flash device, an EPROM, an EEPROM, PROM, a zero power RAM device, or a battery backup RAM device, for example.

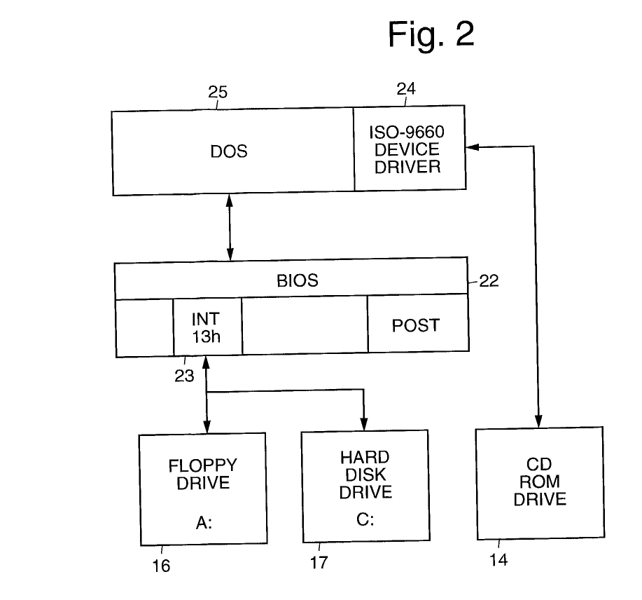

FIG. 2 is a diagram illustrating a typical operating environment in which functions of system firmware 22 (basic input/output system (BIOS) 22) provide access to one or more mass storage devices such as the floppy disk drive 16, the hard disk drive 17, or the CD-ROM 14. The BIOS 22 provides identification and access to the mass storage devices 14, 16, 17 using BIOS functions, such as interrupt (INT) 13h functions. At runtime, the usual BIOS functions do not provide access to the CD-ROM 14 which is instead defined by ISO-9660 device driver software residing in an operating system, such as the disk operation system (DOS).

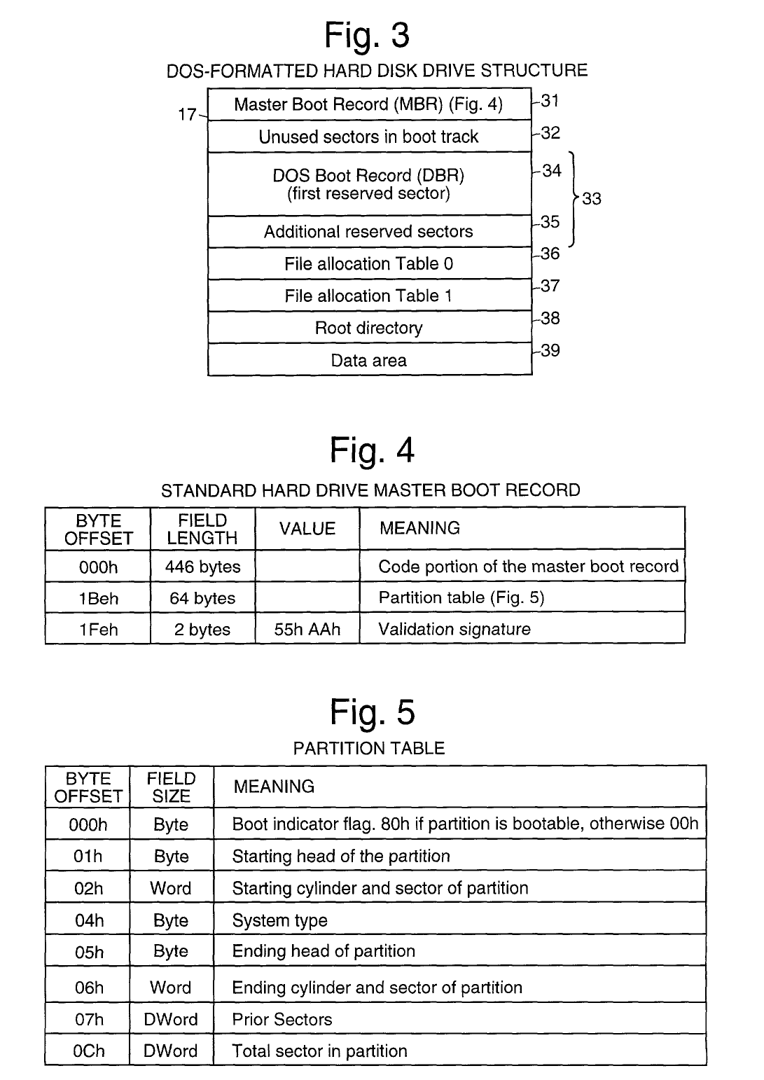

FIG. 3 is a table illustrating the structure of a DOS formatted hard disk drive 17 using a FAT file system. The DOS formatted hard disk drive 17 begins with a Master Boot Record (MBR) 31 (FIG. 4) that contains a partition table (FIG. 5) followed by a number of unused sectors 32 that are usually the remaining sectors in the first track. The boot record 31 is short program that loads the operating system into the system memory 13.

The partition table indicates which, if any, of the partitions is the active partition. It also provides the starting address of each partition. The starting address typically includes starting cylinder, head, and sector information. The first reserved sector is the first sector of a partition and the first reserved sector contains a BIOS parameter block. Therefore, fixed disk drives 17 start with a boot track that contains the Master Boot Record 31 in the first sector. The entire boot track is accounted for in a hidden sectors field of the BIOS parameter block.

Fixed disk drives 17 can also contain a reserved area 33 of at least one sector which is used for a DOS Boot Record (DBR) 34 but may also be formatted with additional reserved sectors 35 other than the sector containing the DOS Boot Record 34. The additional reserved sectors 35 are also accounted for by a parameter in the BIOS parameter block. After the additional reserved sectors 35 are a pair of File Allocation Tables 36, 37 (Tables 0 and 1). Thereafter, there is a root directory 38 that maps files that are stored in a data storage area 39.

As will be explained in more detail below, the present invention adds a new level of virus protection to the system firmware (BIOS) by eliminating the need to execute boot sector code when booting from a mass storage device, such as a hard drive, for example. This is accomplished by moving the functionality of the hard drive boot sector program, or Master Boot Record 31 into the system firmware (BIOS).

FIG. 4 is a table illustrating the structure of the Master Boot Record 31. The Master Boot Record 31 is found in the boot sector of the hard disk drive 17 and contains boot code and the partition table. The purpose of the boot code is to locate the active partition, and then load the operating system corresponding to the active partition.

The standard hard drive boot sector contains a Master Boot Record that is a 512 byte binary image that contains a 446 byte Master Boot Record code section, a 4 entry (64 byte) partition table, and a 2 byte validation signature, as indicated in the “meaning” column of the table shown in FIG. 4. The code portion of the Master Boot Record 31 has a byte offset of 000h and is 446 bytes in size as is indicated in the first row of the table shown in FIG. 4. The partition table has a byte offset of 1Eeh and is 64 bytes in size as is indicated in the second row of the table shown in FIG. 4. The validation signature has a byte offset of 1Feh and is 2 bytes in size as is indicated in the second row of the table shown in FIG. 4. The validation signature is shown in FIG. 4 as having a value of 55h Aah.

FIG. 5 shows the structure of an exemplary partition table contained in the Master Boot Record 31. A partition table shows the allocation of storage space in a hard disk drive 17. Each entry in the partition table relates to a single partition that can contain its own set of operating system files. A partition table entry defines a partition by designating the starting and ending addresses for a partition. Other fields in the partition table define, for example, if the partition is bootable or define the total number of sectors in the partition.

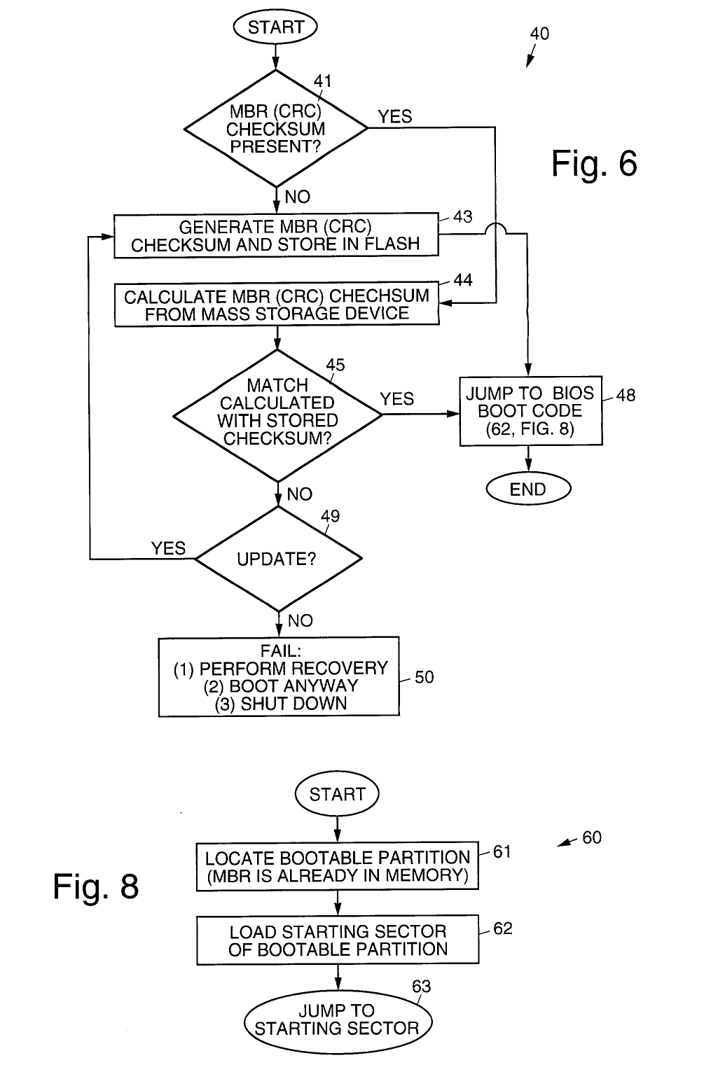

Referring to FIG. 6, it is a flow diagram that illustrates a one-time system initialization method 40 that includes steps that implement boot sector virus protection in accordance with the principles of the present invention. The method 40 starts and it is determined 41 if a flash device checksum (Master Boot Record (MBR) or partition table) checksum, or a cyclic redundancy check (CRC) checksum) is present. If the flash device checksum is not present (No), then a flash device checksum is generated and stored 43 in the nonvolatile memory 20. A jump 48 is then made to BIOS boot code (step 62, FIG. 8) which subsequently executes.

If in step 41, if the MBR (or CRC) checksum is present (Yes), the MBR (or CRC) checksum is calculated 44 from the mass storage device 14, 16, 17. The calculated 44 MBR (or CRC) checksum is matched with the MBR (or CRC) checksum stored in the nonvolatile memory 20. If the MBR (or CRC) checksum in the nonvolatile memory 20 matches 45 the calculated 44 MBR (or CRC) checksum (Yes), a jump 48 is made to BIOS boot code (step 62, FIG. 8) which subsequently executes.

If the flash device checksum in the nonvolatile memory 20 does not match the calculated 44 MBR (or CRC) checksum (No), then a determination is made whether to update 49 the Master Boot Record boot code. If a decision is made to update 49 the Master Boot Record boot code, then the procedure loops to step 43 and the flash device checksum is generated and stored in the nonvolatile memory 20. Then a jump 48 is made to BIOS boot code (FIG. 8). If a decision is made to not update 49 the Master Boot Record boot code, then initialization has failed 50, and several options are provided. The first option is to perform recovery. The second option is to boot anyway. The third option is to shut down the computer system 10.

In step 45, if the calculated and stored values match, this indicates that no changes to the boot code have been made and that a virus is not present. Therefore the boot code in the memory may be used with confidence that a virus is not present in the boot code. However, if the calculated and stored values do not match, this would indicate that the boot code have been changed and that the possibility of a virus exists.

It is to be understood that a portion of the MBR code stored in the nonvolatile memory 20 may be copied from the master boot record, or may be derived from the master boot record, or may be separate from the master boot record.

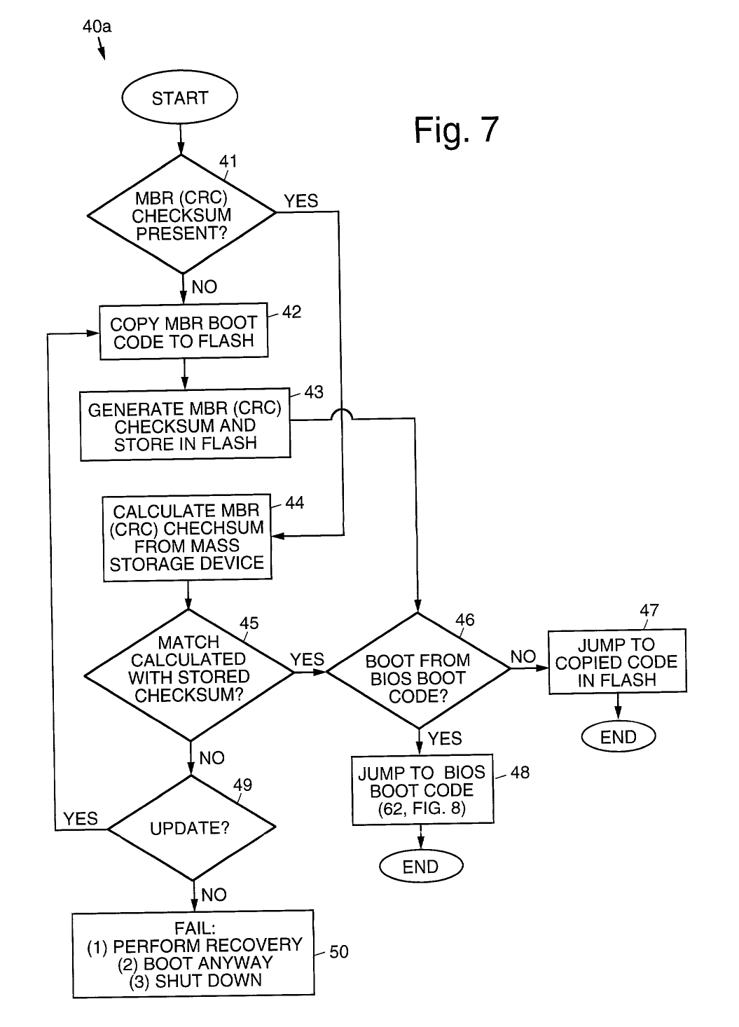

Referring to FIG. 7, it is a flow diagram that illustrates an one-time system initialization procedure that includes steps that implement an alternative boot sector virus protection method 40a in accordance with the principles of the present invention. The alternative method 40a starts and it is determined 41 if a flash device checksum (Master Boot Record (MBR) or partition table checksum, or cyclic redundancy check (CRC) checksum) is present. If the flash device checksum is not present (No), then the Master Boot Record boot code is copied 42 into the nonvolatile memory 20. A flash device checksum is generated and stored 43 in the nonvolatile memory 20. Then, it is determined 46 which BIOS boot code should be booted from, in a manner as will be described in the following paragraph.

In step 41, if it is determined 41 that the flash device checksum is present (Yes), then a Master Boot Record (MBR) (or CRC) checksum is calculated 44. Then, it is determined 45 if the flash device checksum stored in the nonvolatile memory 20 matches the calculated MBR (or CRC) checksum. If the flash device checksum and the calculated 44 MBR (or CRC) checksum match (Yes), then it is determined 46 whether the BIOS boot code is present. If the BIOS boot code is not present (No), a jump 47 is made to the copied Master Boot Record boot code in the nonvolatile memory 20 which subsequently executes. If the BIOS boot code is present (Yes), a jump 48 is made to the BIOS boot code stored in memory (step 62, FIG. 8) which subsequently executes.

In step 45, if the flash device checksum does not match 45 the calculated MBR (or CRC) checksum (No), then a determination is made whether to update 49 the Master Boot Record boot code. If a decision is made to update 49 the Master Boot Record boot code, then the procedure loops to step 42 and the Master Boot Record boot code is copied 42 into the nonvolatile memory 20 and the steps following step 42 repeat.

If a decision is made to not update 49 the Master Boot Record boot code, then initialization has failed 50, and several options are provided. The options are to perform recovery, to boot anyway, or to shut down the computer system 10.

FIG. 8 is a flow diagram of a procedure 60 that illustrates execution of embedded BIOS boot code performed after the procedures described with reference to FIGS. 6 and 7 jump 48 to the BIOS boot code. The execution procedure 60 starts and a bootable partition is located 61 (the MBR is already in memory). The starting sector of the bootable partition is then loaded 62. Then a jump 63 is made to the starting sector and execution begins.

In a simplified embodiment of the present invention, apparatus is provided that copies the boot record of the computer system 10 (which resides on the boot sector of the storage medium 17), and embedding the boot sector of the storage medium 17 into the nonvolatile or flash memory 20. During the boot process, the system 10 will boot from the boot sector of the storage medium 17, as would a traditional system, but will retrieve the code, which resides in the nonvolatile or flash memory 20 and transfer that into system memory 13. The result is that the boot process can be much faster and any boot sector code that contains a virus program, can be bypassed.

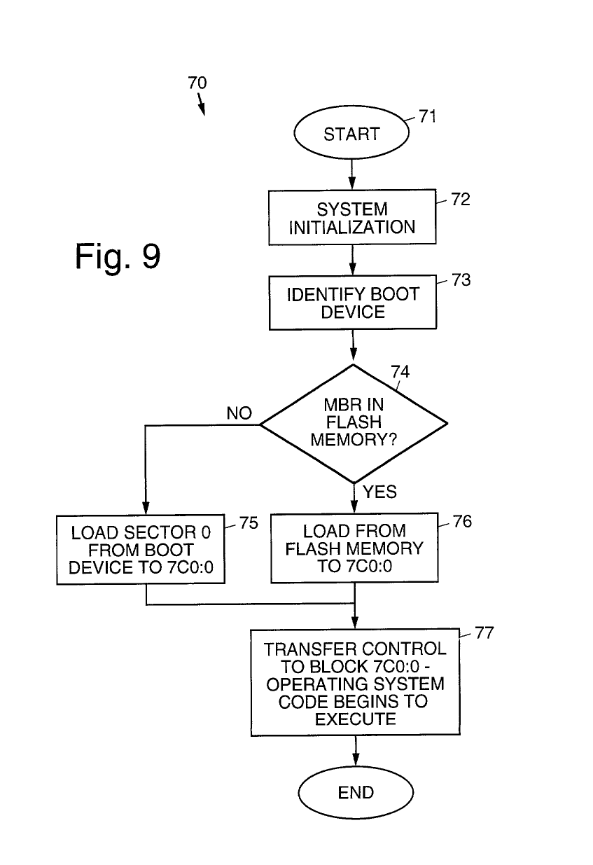

Referring to FIG. 9, it is a flow diagram illustrating a boot process 70 according to a simplified embodiment of the present invention. The boot process 70 starts, for example, when the system 10 powers on 71. The system 10 is then initialized 72. During initialization 72, attached devices are located and their device parameters are ascertained. A boot device is then identified 73. Upon identifying the boot device, it is determined 74 30 if there is a Master Boot Record (MBR) stored in nonvolatile or flash memory 20.

If not, the contents of sector 0 are loaded 75 from the boot device to hexadecimal location 7C0 in system memory 13. Once the bootstrap program has been loaded at location 7C0, control is transferred 77 to location 7C0. Once control has transferred to location 7C0, the operating system code, which begins at location 7C0, begins to execute, signifying the end of the boot process 70.

If however, the master boot record is stored in the nonvolatile or flash memory 20, the boot strap loader is retrieved from the nonvolatile or flash memory 20 and loaded 76 to address 7C0 of the computer. Control is then transferred 77 to location 7C0 (process block 211) thereby terminating the boot process 70.

The present invention thus provides for methods that protect boot strap code from infection by viruses by installing the boot strap loader code into a flash memory, the process can be extended to other areas of code, for example, critical portions of a program, which also can be the targets of viruses.

The Master Boot Record is a favorite attack target of viruses, because it is easy to find. It is generally located in sector 0 of a bootable device. Not only is the Master Boot Record conveniently located (typically in sector 0) of a hard disk drive 17 or floppy drive 16, but there are BIOS services that make it easy to access at that location.

Another common target of viruses is the BIOS parameter block (BPB), also known as the DOS Boot Record 34. The Master Boot Record contains partition tables. There are typically entries in the partition table that point to the DOS Boot Record 34. The DOS Boot Record 34 contains information about the file system. The location ot the DOS Boot Record 34 can easily be determined by reading the location of the DOS Boot Record 34 from the Master Boot Record.

A third common point of entry for viruses is critical operating system files. Viruses can attach to critical operating system files by going to the root directory, which is at a fixed offset from a given partition. Within the root directory, there are pointer strings that point to the critical files. For example, IO.sys, auto exec.bat, MSDOS.sys, and WIN.sys, for example.

Therefore, in addition to copying the Master Boot Record into flash memory 20 and validating it, further embodiments of the present invention copy the BIOS parameter block or DOS Boot Record 34 into flash memory 20 and subsequently validating the contents of the flash memory 20. In applications where security is of a heightened concern, the critical operating system files can also be copied into flash memory 20 or other suitable nonvolatile memory 20 and validated.

The present invention also provides for additional protection features as will be discussed below. When a hard disk drive 17 is initialized, its maximum size is set, predetermined or pre-allocated. Certain hard disk drives 17 have commands called SETMAX, that allocate or set the maximum size of the hard disk drive 17. In some of those hard disk drives 17, areas outside of the SETMAX parameters cannot be accessed. In addition, some of the hard disk drives 17 do not allow the use of a SETMAX command without a particular password. In such cases, a password can be written into nonvolatile or flash memory 20 and/or other secure memory device, that is subsequently used to access the area of the hard disk drive 17 beyond the SETMAX parameter.

Since the area outside of the location defined by the SETMAX command can only be accessed through the use of the SETMAX password, the password-accessible area is relatively secure from viruses. In addition, by placing the password in flash memory 20 and updating it between system boot cycles, the password-accessible area of the hard disk drive 17 beyond the SETMAX parameter limits can be made even more inaccessible to viruses. Additionally, the SETMAX password can be made user-dependent. That is, instead of using a common ASCII type string, the SETMAX password may comprise a digital string of numbers that is user-dependent. Such user-dependent passwords may include a biometric, such as the reading of thumb print, or the output from a retinal scan. By using user-dependent passwords, the potential for attack of the system by viruses would be minimized. This is because the viruses would not be able to obtain the password necessary to access the system parameters stored beyond the SETMAX limits of the hard disk drive 17.

From the above, it should be apparent that embodiments of the present invention make computer systems 10 less vulnerable by moving the boot code out of the vulnerable boot sector, by making access to the files more difficult by storing them in different types of nonvolatile memory and making access to them more difficult using techniques such as password protection and storing of the files in a secure area.

In addition to the above, the present apparatus and methods may also issue a warning to a user of the computer system in the event that the stored checksum does not match a checksum computed when booting the computer system 10. The apparatus and methods may update the boot record code by copying new boot record code to an Extended System Configuration Data memory area to provide a boot loader for the system firmware (BIOS).

Thus, a boot sector virus protection apparatus and methods have been disclosed. It is to be understood that the above-described embodiments are merely illustrative of some of the many specific embodiments that represent applications of the principles of the present invention. Clearly, numerous and other arrangements can be readily devised by those skilled in the art without departing from the scope of the invention.

What is claimed is:

1. A virus protection method for use with a computer system having a nonvolatile memory and a mass storage device with a master boot record containing a partition table, the method comprising the steps of:
storing code in the nonvolatile memory that is capable of reading the partition table in the master boot record stored in the mass storage device; and
using the stored code to read the master boot record, locate the partition table in the master boot table, locate a bootable partition within the partition table, and begin a boot process using the bootable partition.

2. The virus protection method recited in claim 1 further comprising the steps of:
using the stored code to check the master boot record stored in the mass storage device has been changed since a prior determination.

3. The virus protection method recited in claim 2 wherein the master boot record stored in a secure area of the mass storage device.

4. The virus protection method recited in claim 1 further comprising the steps of:
using the stored code to calculate a value related to the master boot record stored in the mass storage device to determine if the master boot record has been changed since a prior determination.

5. The virus protection method recited in claim 4 further comprising the steps of:
if a value related to the master boot record is not present, calculating the value related to the master boot record; and
storing the calculated value in the nonvolatile memory.

6. The virus protection method recited in claim 1 wherein the value is a checksum of the master boot record.

7. The virus protection method recited in claim 6 wherein the value is a cyclic redundancy check of the master boot record.

8. The virus protection method recited in claim 1 wherein the value is a checksum of the partition table of the master boot record.

9. The virus protection method recited in claim 1 wherein the value is a cyclic redundancy check of the partition table of the master boot record.

10. The virus protection method recited in claim 1 wherein a portion of the code stored in the nonvolatile memory is copied from the master boot record.

11. The virus protection method recited in claim 1 wherein a portion of the code stored in the nonvolatile memory is derived from the master boot record.

12. The virus protection method recited in claim 1 wherein the code is separate from the master boot record.

13. The virus protection method recited in claim 4 wherein, when the value stored in the nonvolatile memory does not match the value calculated from the master boot record, using the stored code to update the master boot record.

14. Virus protection apparatus comprising:
a computer system having a nonvolatile memory and a mass storage device with a master boot record containing a partition table;
code stored in the nonvolatile memory that is capable of reading the partition table in the master boot record stored in the mass storage device and which is capable of reading the master boot record, locating the partition table in the master boot table, locating a bootable partition within the partition table, and beginning a boot process using the bootable partition.

15. The virus protection apparatus recited in claim 14 wherein the stored code checks the master boot record stored in the mass storage device to determine if it has been changed since a prior determination.

16. The virus protection apparatus recited in claim 15 wherein the master boot record stored in a secure area of the mass storage device.

17. The virus protection apparatus recited in claim 14 wherein the stored code calculates a value related to the master boot record stored in the mass storage device to determine if the master boot record has been changed since a prior determination.

18. The virus protection apparatus recited in claim 14 wherein if a value related to the master boot record is not present, the code calculates the value related to the master boot record and stores it in the nonvolatile memory.

19. The virus protection apparatus recited in claim 17 wherein the value is selected from a group including a checksum of the master boot record, a checksum of the partition table of the master boot record, a cyclic redundancy check of the master boot record, and a cyclic redundancy check of the partition table of the master boot record.

20. The virus protection apparatus recited in claim 14 wherein a portion of the code stored in the nonvolatile memory is copied from the master boot record.

21. The virus protection apparatus recited in claim 14 wherein a portion of the code stored in the nonvolatile memory is derived from the master boot record.

22. The virus protection apparatus recited in claim 14 wherein the code is separate from the master boot record.

23. The virus protection apparatus recited in claim 17 wherein, when the value stored in the nonvolatile memory does not match the value calculated from the master boot record, the stored code is used to update the master boot record.
